(19) United States
(12) Patent Application Publication
(10) Pub. No.: US 2013/0323051 A1
(43) Pub. Date: Dec. 5, 2013

(54) WIND TURBINE GENERATOR AND VALVE FUNCTION CHECKING METHOD FOR WIND TURBINE GENERATOR

(71) Applicants: Atsushi YUGE, Tokyo (JP); Toshikazu HAYASHI, Tokyo (JP); Masato YAMADA, Tokyo (JP)

(72) Inventors: Atsushi YUGE, Tokyo (JP); Toshikazu HAYASHI, Tokyo (JP); Masato YAMADA, Tokyo (JP)

(73) Assignee: MITSUBISHI HEAVY INDUSTRIES, LTD., Tokyo (JP)

(21) Appl. No.: 13/484,373

(22) Filed: May 31, 2012

(51) Int. Cl. F03D 7/04; F03D 11/00; F03D 1/06

(52) U.S. Cl. 416/1; 416/98

(57) ABSTRACT

An object is to facilitate checking of functional normality of a pilot check valve. A wind turbine generator includes a pilot check valve for restricting a flow of hydraulic oil relative to each oil hydraulic cylinder for changing a pitch angle of each blade, and the pilot check valve functions for fixing the pitch angle of the blade to a feather position in a state in which rotation of the blade is stopped. The function of the pilot check valve may be hindered. The wind turbine generator detects an operation state of the blade during a process of changing the pitch angle of the blade from the feather position to a fine position, and compares the detected operation state of the blade to an operation state of the blade when the pilot check valve functions normally, to determine whether or not there is any abnormality in the pilot check valve.

### TECHNICAL FIELD

The present invention relates to a wind turbine generator and a valve function checking method for a wind turbine generator.

### BACKGROUND ART

Conventionally, a control operation is provided on a pitch angle of blades equipped to a wind turbine generator.

Patent Literature 1 discloses a blade pitch angle variable mechanism of a wind turbine generator having a structure including oil hydraulic cylinders used as actuators, each of which slides a push-pull rod so as to change a pitch angle of blades.

FIG. 11 illustrates a variable mechanism of blades using oil hydraulic cylinders.

In an example of FIG. 11, a tip of a rod 202A included in a piston 202 of each oil hydraulic cylinder 200, at least one portion of which is supported by a rotor hub (not illustrated), is coupled to a position apart from a center of a blade root shaft that is rotatably held to the rotor hub through a bearing. Hydraulic oil is supplied to each oil hydraulic cylinder 200, and the piston 202 moves in each oil hydraulic cylinder 200 so that a blade coupled to each rod 202A rotates on the bearing to change its pitch angle.

Each blade is closed by setting its pitch angle at the feather position so as to pass through wind when the wind turbine generator is shut down (power down). During this time, a pilot check valve 206 equipped in an oil hydraulic circuit 204 for supplying hydraulic oil to each oil hydraulic cylinder 200 restricts a flow of the hydraulic oil flowing in the oil hydraulic cylinder 200, so as to fix the pitch angle of each blade to the feather position.

### CITATION LIST

### Patent Literature

{PTL 1} Japanese Unexamined Patent Application, Publication No. 2002-31031

### SUMMARY OF INVENTION

### Technical Problem

However, the function of the pilot check valve 206 may be hindered by contaminants (impurities) mixed in the hydraulic oil during a replacing operation of the oil hydraulic cylinder 200, or due to abrasion of a seat of the pilot check valve, for example. In such a case, the pilot check valve 206 cannot restrict the flow of the hydraulic oil. As a result, the pitch angle of each blade cannot be fixed to the feather position, and the blades rotate excessively when receiving a strong wind, which may cause damage to the wind turbine generator, for example.

The present invention has been made in the light of the above-described circumstances, and has an object to provide a wind turbine generator and a valve function checking method for a wind turbine generator capable of facilitating checking of functional normality of a pilot check valve that restricts a flow of hydraulic oil in each oil hydraulic cylinder for changing a pitch angle of each blade of the wind turbine generator.

### Solution to Problem

In order to solve the above-described problems, the wind turbine generator and the valve function checking method for the wind turbine generator according to the present invention employ the following solutions.

A wind turbine generator according to the first aspect of the present invention includes a pilot check valve for restricting a flow of hydraulic oil relative to an oil hydraulic cylinder for changing a pitch angle of a blade, and the pilot check valve functions for fixing the pitch angle of the blade to a feather position in a state in which rotation of the blade is stopped. The wind turbine generator further includes a detection unit for detecting an operation state of the blade during a process of changing the pitch angle of the blade from the feather position to a fine position, a memory unit for storing in advance a normal operation state that is an operation state of the blade during a process of changing the pitch angle of the blade from the feather position to the fine position when the pilot check valve functions normally, and a determination unit for determining whether or not there is any abnormality in the pilot check valve by comparing the operation state of the blade detected by the detection unit to the normal operation state stored on the memory unit in advance.

According to the first aspect of the present invention, the wind turbine generator includes the pilot check valve for restricting the flow of the hydraulic oil relative to an oil hydraulic cylinder for changing the pitch angle of a blade, and the pilot check valve functions for fixing the pitch angle of the blade to the feather position in the state in which rotation of the blade is stopped.

The pilot check valve may be hindered by contaminants (impurities) mixed in the hydraulic oil during a replacing operation of the oil hydraulic cylinder or abrasion of a seat of the pilot check valve.

Hence, the wind turbine generator detects the operation state of the blade during the process of changing the pitch angle of the blade from the feather position to a fine position by using the detection unit.

The memory unit stores in advance the normal operation state that is an operation state of the blade during the process of changing the pitch angle of the blade from the feather position to the fine position when the pilot check valve functions normally.

The determination unit determines whether or not there is any abnormality in the pilot check valve by comparing the operation state of the blade detected by the detection unit to the normal operation state stored on the memory unit in advance.

Specifically, the function of the pilot check valve is hindered and oil leakage occurs in the pilot check valve, so that the pressure of the hydraulic oil in the oil hydraulic cylinder is decreased, thus the operation state of the blade during the process of changing the pitch angle of the blade from the feather position to the fine position differs from the normal operation state. Accordingly, it can be determined whether or not there is any abnormality in the pilot check valve by comparing the detected operation state of the blade detected by the detection unit to the normal operation state.

Accordingly, the wind turbine generator according to the first aspect of the present invention can readily check the normality in the function of the pilot check valve for restricting the flow of the hydraulic oil relative to the oil hydraulic cylinder for changing the pitch angle of the blade.

The wind turbine generator according to the first aspect of the present invention may further include a solution unit for solving an abnormality in the pilot check valve by generating a flow of the hydraulic oil for allowing the oil hydraulic cylinder to operate repetitively if it is determined by the determination unit that there is an abnormality in the pilot check valve.

The present invention according to the first aspect generates the flow of the hydraulic oil for enabling the oil hydraulic cylinder to operate repetitively, thereby removing the contaminants mixed in the pilot check valve from the pilot check valve, and thus the pilot check valve can readily be recovered from the abnormal state to the normal state.

In the wind turbine generator according to the first aspect of the present invention, the operation state may include a relation between change amount of the pitch angle of the blade and time duration required for changing the pitch angle of the blade.

In the first aspect of the present invention, the operation state of each blade used for determining whether or not there is any abnormality in the pilot check valve is based on the relation between the change amount of the pitch angle of each blade and the time duration required for changing the pitch angle of each blade. Accordingly, no new configuration is necessary for detecting the operation state of each blade, which facilitates the determination of the abnormality in the pilot check valve. A specific example of the above relation includes an operation time required for the pitch angle of the blade to change at a predetermined angle or a degree of the pitch angle of the blade within predetermined time duration.

In the wind turbine generator according to the first aspect of the present invention, the operation state may include pressure of the hydraulic oil supplied to the oil hydraulic cylinder.

According to the first aspect of the present invention, the operation state of the blade for determining whether or not there is any abnormality in the pilot check valve includes the pressure of the hydraulic oil supplied to the oil hydraulic cylinder. Since the pressure of the hydraulic oil is directly subject to influence from hindrance of the function of the pilot check valve, the wind turbine generator according to the first aspect of the present invention can determine whether or not there is any abnormality in the pilot check valve with higher accuracy.

In the wind turbine generator according to the first aspect of the present invention, a maintenance port for supplying the hydraulic oil to the oil hydraulic cylinder may be provided in order to enable the pitch angle of the blade at the feather position to be changed to the fine position, and the maintenance port may be disposed between the oil hydraulic cylinder and a pump for supplying the hydraulic oil to the oil hydraulic cylinder at a time of a normal operation, and the detection unit may detect the operation state of the blade when the hydraulic oil is supplied from the maintenance port in order to change the pitch angle of the blade at the feather position to the fine position.

According to the first aspect of the present invention, the maintenance port may be disposed between the oil hydraulic cylinder and the pump for supplying the hydraulic oil to the oil hydraulic cylinder at the time of the normal operation in order to change the pitch angle of the blade at the feather position to the fine position. The detection unit detects the operation state of the blade when the hydraulic oil is supplied from the maintenance port in order to change the pitch angle of the blade at the feather position to the fine position.

The maintenance port is disposed more closely to the oil hydraulic cylinder than the pump for supplying the hydraulic oil to the oil hydraulic cylinder. Therefore, the configuration of supplying the hydraulic oil from the maintenance port to the oil hydraulic cylinder can reduce influence on the operation state of the blade due to pressure loss of the hydraulic oil, compared to the configuration of supplying the hydraulic oil from the pump to the oil hydraulic cylinder.

Accordingly, the wind turbine generator according to the first aspect of the present invention can determine whether or not there is any abnormality in the pilot check valve with higher accuracy.

The valve function checking method for the wind turbine generator according to the second aspect of the present invention includes a pilot check valve for restricting a flow of hydraulic oil relative to an oil hydraulic cylinder for changing a pitch angle of a blade, and the pilot check valve functions for fixing the pitch angle of the blade to a feather position in a state in which rotation of the blade is stopped. The valve function checking method includes a first stage of detecting an operation state of the blade during a process of changing the pitch angle of the blade from the feather position to a fine position, and a second stage of determining whether or not there is any abnormality in the pilot check valve by comparing the operation state of the blade detected by the first stage to a normal operation state stored on a memory unit in advance, the normal operation state being an operation state of the blade during a process of changing the pitch angle of the blade from the feather position to the fine position when the pilot check valve functions normally.

According to the second aspect of the present invention, if the function of the pilot check valve is hindered and oil leakage occurs on the pilot check valve, the pressure of the hydraulic oil in the oil hydraulic cylinder is decreased, thus the operation state of each blade during the process of changing the pitch angle of the blade from the feather position to the fine position differs from the normal operation state; therefore, it can be determined whether or not there is any abnormality in the pilot check valve by comparing the detected operation state of each blade to the normal operation state.

The valve function checking method for the wind turbine generator according to the second aspect of the present invention facilitates checking of functional normality of a pilot check valve for restricting a flow of hydraulic oil in each oil hydraulic cylinder that changes a pitch angle of each blade of the wind turbine generator.

### Advantageous Effects of Invention

The present invention achieves an excellent effect that facilitates checking of functional normality of a pilot check valve for restricting a flow of hydraulic oil in oil hydraulic cylinders that change a pitch angle of the blades of the wind turbine generator.

### BRIEF DESCRIPTION OF DRAWINGS

FIG. 1 is an outline drawing of the wind turbine generator according to the first embodiment of the present invention.

FIG. 2A is a schematic diagram of an overall configuration of an oil hydraulic circuit of a blade pitch driving mechanism of the wind turbine generator according to the first embodiment of the present invention.

FIG. 2B is a diagram of illustrating positions of a piston in the cases of setting a pitch angle of the blade to a feather position and to a fine position in FIG. 2A.

FIG. 3 is a block diagram of illustrating an electric configuration of the wind turbine generator regarding control on the pitch angle of the blades of the wind turbine generator according to the first embodiment of the present invention.

FIG. 4 is a cross sectional view of the pilot check valve according to the first embodiment of the present invention.

FIG. 5 is a flow chart of illustrating a process flow of a function checking program of the pilot check valve according to the first embodiment of the present invention.

FIG. 6A is a graph showing time change of the pitch angle of the blade in an operation state of the blade according to the first embodiment of the present invention.

FIG. 6B is a diagram showing pressure of a hydraulic oil discharged from a pump in an operation state of the blade according to the first embodiment of the present invention.

FIG. 6C is a diagram showing a state of a changeover control signal output from a control system to a changeover valve in an operation state of the blade according to the first embodiment of the present invention.

FIG. 7 is a diagram of illustrating an oil hydraulic circuit of a blade pitch driving mechanism according to the second embodiment of the present invention.

FIG. 8A is a graph of showing change in pressure of the hydraulic oil in an operation state of the blade according to the second embodiment of the present invention.

FIG. 8B is a drawing of illustrating pressure of the hydraulic oil discharged from the pump in an operation state of the blade according to the second embodiment of the present invention.

FIG. 8C is a drawing of illustrating a state of a changeover control signal output from a control system to a changeover valve in an operation state of the blade according to the second embodiment of the present invention.

FIG. 9 is a diagram of an oil hydraulic circuit of a blade pitch driving mechanism according to the third embodiment of the present invention.

FIG. 10 is a diagram of an oil hydraulic circuit of a blade pitch driving mechanism according to another embodiment of the present invention.

FIG. 11 is a diagram of an oil hydraulic circuit of a blade pitch driving mechanism of a prior art.

### DESCRIPTION OF EMBODIMENTS

Hereinafter, descriptions will be provided on one embodiment of the wind turbine generator and the valve function checking method for the wind turbine generator according to the present invention with reference to the drawings.

### First Embodiment

Hereinafter descriptions will be provided on the first embodiment of the present invention.

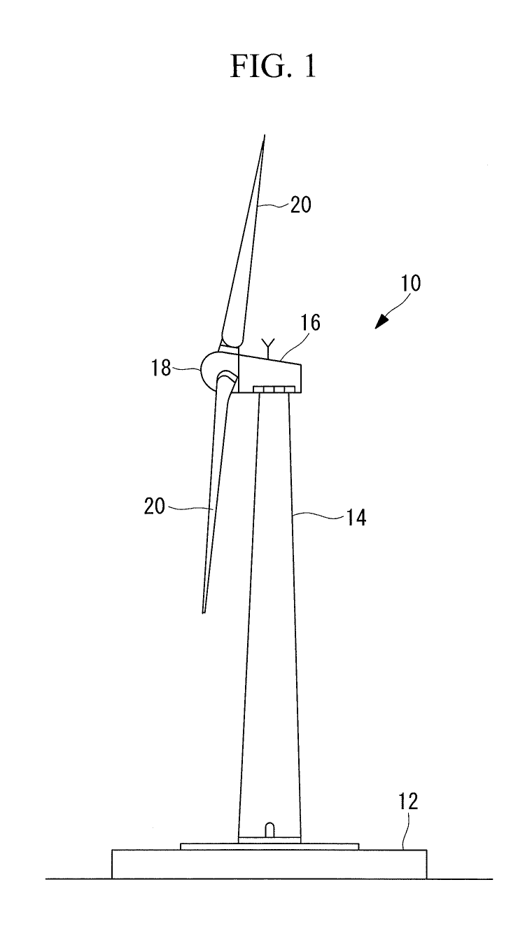

FIG. 1 is an outline drawing of the wind turbine generator 10 according to the first embodiment.

The wind turbine generator 10 as shown in FIG. 1 includes the tower 14 standing on the base 12, the nacelle 16 provided at an upper end of the tower 14, and the rotor head 18 provided on the nacelle 16 so as to rotate about a substantially horizontal shaft line thereof.

A plurality of (three as one example in the first embodiment) wind turbine rotation blades (hereinafter referred to simply as “blades 20”) are radially equipped around the rotational shaft line of the rotor head 18. According to the above configuration, wind force blown against the blades 20 in the direction of the rotational shaft line of the rotor head 18 is converted into motive power to rotate the rotor head 18 around the rotational shaft line, and this motive power is converted into electric power by the generator. The blades 20 are coupled to the rotor head 18 so as to be rotatable relative to the wind direction, and the pitch angle of each blade 20 is variable.

The wind turbine generator 10 according to the first embodiment uses oil pressure to change the pitch angle of each blade 20.

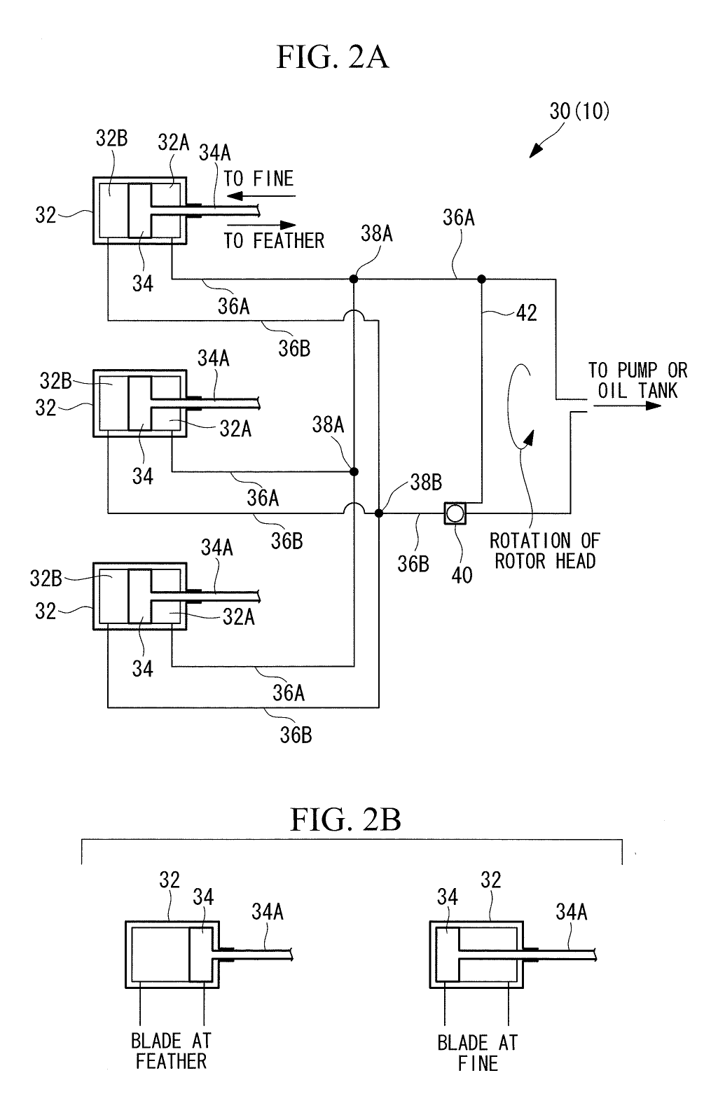

FIG. 2A is a schematic diagram of the oil hydraulic circuit 30 of the blade pitch driving mechanism of the wind turbine generator 10 according to the first embodiment. The oil hydraulic circuit 30 is installed in the rotor head 18. A pump installed in the nacelle 16 supplies (discharges) the hydraulic oil in an oil tank to the oil hydraulic circuit 30 through a rotary joint (not illustrated).

The oil hydraulic circuit 30 according to the first embodiment includes the oil hydraulic cylinders 32 each of which changes the pitch angle of each blade 20, and each blade 20 is coupled to a tip of the rod 34A of the piston 34 included in each oil hydraulic cylinder 32.

More specifically, at least one portion of each oil hydraulic cylinder 32 is supported by the rotor hub (not illustrated). The rod 34A is a cylindrical member, which is coaxially disposed to the shaft line of each oil hydraulic cylinder 32 and linearly movable along this shaft line. The tip of the rod 34A is coupled to a position apart from the axial center of the root of the blade 20 that is rotatably held to the rotor hub through the bearing.

When the hydraulic oil is supplied to the oil hydraulic cylinder 32, the piston 34 moves in the oil hydraulic cylinder 32, and along with this movement of the piston 34, the rod 34A is pushed out or drawn in along the axial line of the oil hydraulic cylinder 32. Hence, each blade 20 coupled to the rod 34A rotates on the bearing, thereby changing the pitch angle of each blade 20.

As illustrated in FIG. 2B, when the piston 34 is pushed most outward of the oil hydraulic cylinder 32, the pitch angle of the blade 20 is set to the feather position. When the piston 34 is drawn most inward of the oil hydraulic cylinder 32, the pitch angle of the blade 20 is set to the fine position.

In the oil hydraulic cylinder 32, the hydraulic oil supply passage 36A is connected to the oil pressure chamber 32A working for pushing the piston 34 into the oil hydraulic cylinder 32, and the hydraulic oil supply passage 36B is connected to the oil pressure chamber 32B working for pushing the piston 34 outward of the oil hydraulic cylinder 32.

The hydraulic oil supply passages 36A, 36B are branched by the branches 38A, 38B, and these branched hydraulic oil supply passages 36A, 36B serve for supplying the hydraulic oil to each oil hydraulic cylinder 32.

Hence, in an example of the oil hydraulic circuit 30 illustrated in FIG. 2(A), the hydraulic oil is equally supplied to each piston 34, thus each pitch angle of the three blades 20 is equally changed at the same timing.

The pilot check valve 40 that is a pilot check valve is disposed more closely to the pump than the branch 38B of the hydraulic oil supply passage 36B.

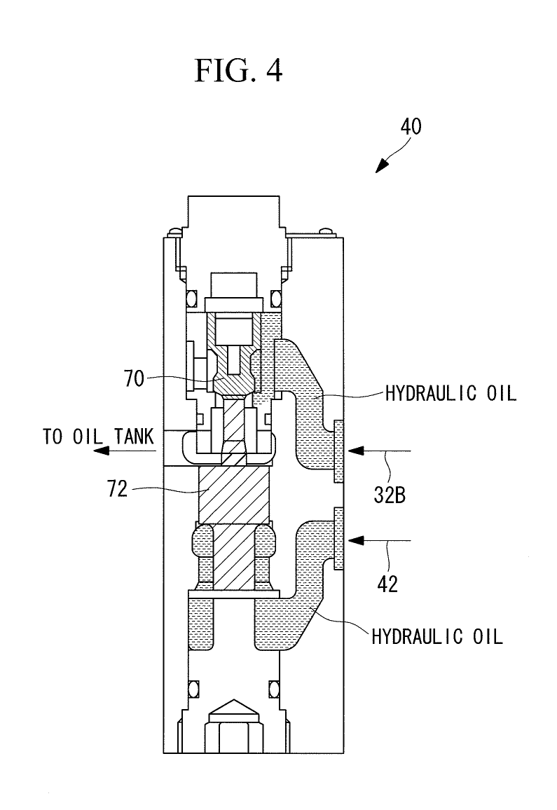

The pilot check valve 40 does not restrict the flow of the hydraulic oil from the pump to the oil pressure chamber 32B (right to left in FIG. 2(A)), but restricts the flow of the hydraulic oil from the oil pressure chamber 32B to the pump (left to right in FIG. 2(A)). The branch passage 42 branched from the hydraulic oil supply passage 36A is connected to the pilot check valve 40, so that the restriction of the pilot check valve 40 on the flow of the hydraulic oil from the oil pressure chamber 32B to the pump is released when the hydraulic oil flowing in the branch passage 42 opens the valve body 70 (see FIG. 4 also) of the pilot check valve 40.

The wind turbine generator 10 according to the first embodiment stays in a state in which the oil pressure chamber 32B is filled with the hydraulic oil at a predetermined pressure (8 Mpa, for example) and the piston 34 is pushed most outward of the oil hydraulic cylinder 32 while the wind turbine generator 10 is shut down. Hence, the pitch angle of each blade 20 is set to the feather position, where the flow of the hydraulic oil is restricted by the pilot check valve 40, thereby fixing the pitch angle of each blade 20 to the feather position.

Meanwhile, during the normal operation in the wind turbine generator 10, the hydraulic oil is supplied to the oil pressure chamber 32A in order to change the pitch angle of each blade 20 to the fine position. At this time, the hydraulic oil is also supplied to the pilot check valve 40 through the branch passage 42, so that the valve body 70 of the pilot check valve 40 is opened and the hydraulic oil is exhausted from the oil pressure chamber 32B, thus the piston 34 is pushed into the oil hydraulic cylinder 32, thereby changing the pitch angle of each blade 20 to the fine position.

When the hydraulic oil is supplied to the oil pressure chamber 32A and the piston 34 is pushed into the oil hydraulic cylinder 32, the hydraulic oil in the oil pressure chamber 32B is returned into the oil tank in the nacelle 16. Reversely, when the hydraulic oil is supplied to the oil pressure chamber 32B and the piston 34 is pushed outward of the oil hydraulic cylinder 32, the hydraulic oil in the oil pressure chamber 32A is returned to the oil tank in the nacelle 16.

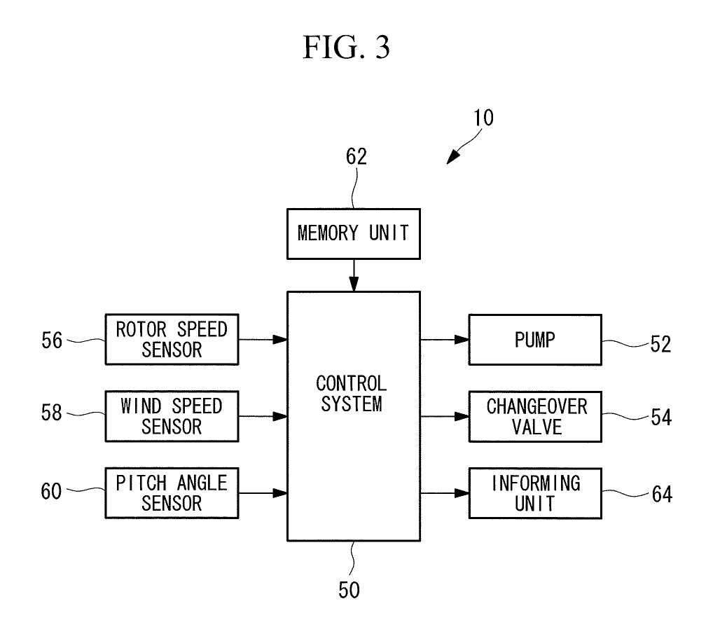

FIG. 3 illustrates the electric configuration of the wind turbine generator 10 regarding the control on the pitch angle of the blades 20.

The control system 50 controls the entire of the wind turbine generator 10, and controls various control targets such as the pump 52 for supplying the hydraulic oil to the oil hydraulic circuit 30 and the changeover valve 54 for switching the supply destination (the oil pressure chamber 32A or the oil pressure chamber 32B) to which the hydraulic oil is supplied by using the pump 52 based on the input signal.

The rotor speed sensor 56 detects the rotation speed of the rotor head 18, and outputs this as a rotation speed signal to the control system 50.

The wind speed sensor 58 detects wind speed against the wind turbine generator 10 and outputs this as a wind speed signal to the control system 50.

The pitch angle sensor 60 detects the pitch angle of each blade 20, and outputs this as a pitch angle signal to the control system 50.

The memory unit 62 includes a magnetic memory or a semiconductor memory, and stores various information. When the pilot check valve 40 functions normally, the memory unit 62 according to the first embodiment stores in advance the normal operation state data that indicate a normal operation state of the blades 20 in the process of changing the pitch angle of each blade 20 from the feather position to the fine position.

The informing unit 64 includes a monitor, a speaker and other components, and informs an operator, for example, of various information regarding the wind turbine generator 10.

With reference to the cross sectional view of the pilot check valve 40 as illustrated in FIG. 4, detailed descriptions will now be provided on the operation of the pilot check valve 40. The arrow in FIG. 4 indicates the flowing direction of the hydraulic oil that is pushed outward of the oil pressure chamber 32B by supplying the hydraulic oil to the oil pressure chamber 32A.

As described above, the hydraulic oil supply passage 36B communicated with the oil pressure chamber 32B, the branch passage 42 and the hydraulic oil supply passage 36B communicated with the oil tank are connected to the pilot check valve 40.

The hydraulic oil in the oil pressure chamber 32B is blocked by closing the valve body 70 so as not to flow into the oil tank (pump). For the purpose of changing the pitch angle of each blade 20 to the fine position, the hydraulic oil is supplied to the oil pressure chamber 32A, so that the hydraulic oil flows from the branch passage 42 into the pilot check valve 40. At this time, if the pressure of the hydraulic oil supplied to the oil pressure chamber 32A exceeds a predetermined value (8 Mpa for example), the pilot valve 72 pushes the valve body 70, so that the hydraulic oil supply passage 36B communicated with the oil pressure chamber 32B comes into communication with the hydraulic oil supply passage 36B communicated with the oil tank. Accordingly, the hydraulic oil in the oil pressure chamber 32B is exhausted as well as the piston 34 is pushed into the oil hydraulic cylinder 32, so as to change the pitch angle of the blade 20 to the fine position.

The operation of the wind turbine generator 10 according to the first embodiment will now be described.

The wind turbine generator 10 according to the first embodiment sets the pitch angle of each blade 20 to the feather position during the shutdown, as described above. The pilot check valve 40 functions for maintaining the pitch angle of each blade 20 to be fixed to the feather position.

The function of the pilot check valve 40 may, however, be hindered due to abrasion of the seat of the pilot check valve or by contaminants (impurities) mixed into the hydraulic oil and caught between the pilot valve 72 and the valve body 70 at the time of a replacing operation of the oil hydraulic cylinder 32, for example. In such a case, the hydraulic oil flows out of the oil pressure chamber 32B into the oil tank even if no pressure of the hydraulic oil from the branch passage 42 is applied to the pilot valve 72.

Such hindrance of the function of the pilot check valve 40 impedes the fixation of the pitch angle of the blade 20 to the feather position, which varies the pitch angle of the blade 20. Consequently, the blade 20 receives the wind, and the rotor head 18 equipped with the blades 20 rotates excessively at the time of high speed wind, which may cause damage to the wind turbine generator 10.

To counter this problem, the wind turbine generator 10 according to the first embodiment performs the function checking process of the pilot check valve for determining whether or not the pilot check valve 40 normally functions.

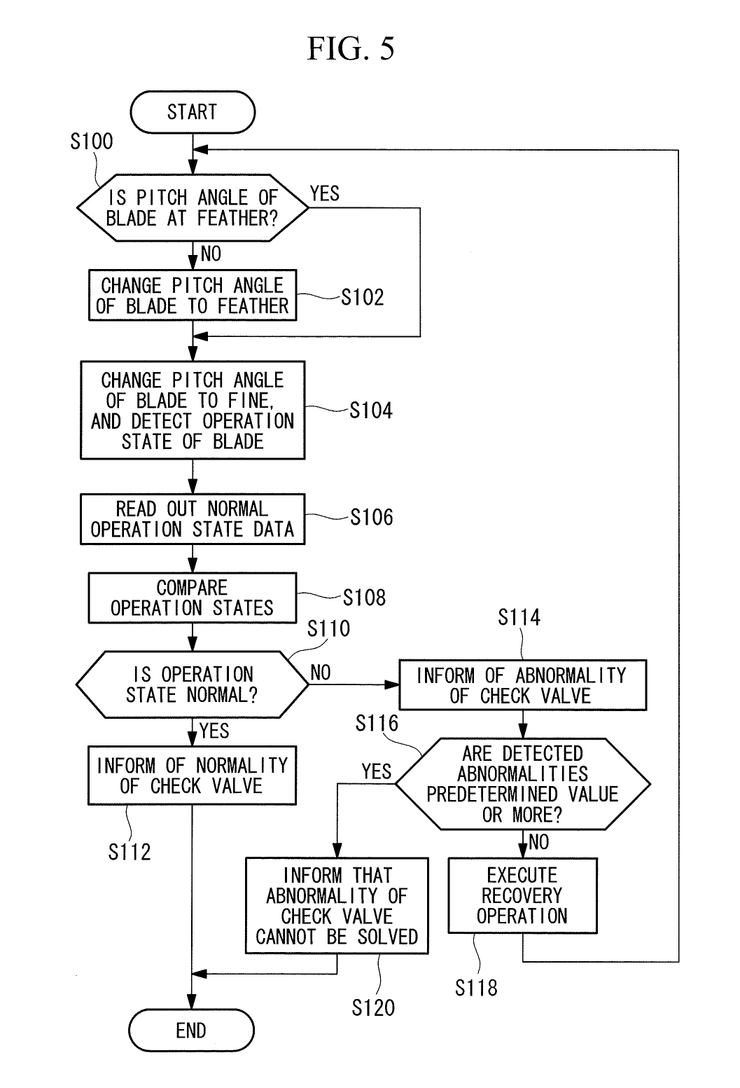

FIG. 5 is a flow chart of illustrating the process flow of the function checking program of the pilot check valve, which is executed by the control system 50 in the function checking process of the pilot check valve. The function checking program of the pilot check valve is stored in a predetermined area of the memory unit in advance. The function checking process of the pilot check valve is executed in response to an input of an execution instruction of the function checking process of the pilot check valve through a control panel (not illustrated) for controlling the wind turbine generator 10, for example.

In Step 100, it is determined based on the pitch angle signal output from the pitch angle sensor 60 whether or not the pitch angle of each blade 20 is at the feather position, and if the determination is “Yes”, the process shifts to Step 104, and if the determination is “No”, the process shifts to Step 102.

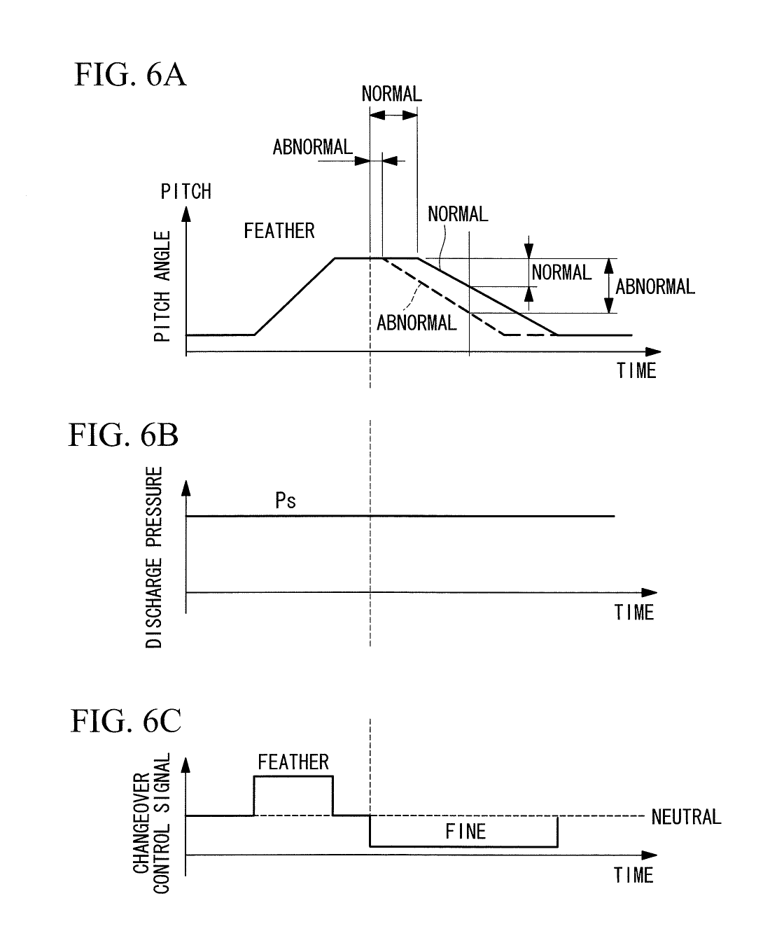

In Step 102, in order to change the pitch angle of each blade 20 to the feather position, a changeover control signal (see FIG. 6C also) is output to the changeover valve 54 as well as a driving signal to drive the pump 52 is output to the pump.

In Step 104, in order to change the pitch angle of each blade 20 to the fine position, the changeover control signal (see FIG. 6C also) is output to the changeover valve 54 as well as the driving signal to drive the pump 52 is output to the pump, and the operation state of the blades 20 during the process of the pitch angle of each blade 20 changing from the feather position to the fine position is also detected.

In Step 106, the normal operation state data is read out from the memory unit 62.

In Step 108, the operation state of the blade 20 detected in Step 104 is compared to the operation state of the blade 20 indicated in the normal operation state data read out in Step 106.

In the first embodiment, the operation state of the blade 20 is defined by a relation between the change amount of the pitch angle of the blade 20 and the time duration required for changing the pitch angle of the blade 20.

FIG. 6A is a graph showing the time change of the pitch angle of each blade 20.

The solid line in FIG. 6A shows the time change of the pitch angle of each blade 20 when the pilot check valve 40 functions normally. Specifically, the time change indicated in the solid line represents the operation state of each blade 20 indicated in the normal operation state data.

The broken line in FIG. 6A represents the time change of the pitch angle of each blade 20 when abnormality occurs in the function of the pilot check valve 40.

FIG. 6B is a diagram showing the pressure (discharge pressure) of the hydraulic oil discharged from the pump 52, and the discharge pressure of the hydraulic oil is set constant all the time.

FIG. 6C is a diagram showing the state of the changeover control signal output from the control system 50 to the changeover valve 54, and one of the feather, the neutral and the fine signals is selectively output as the changeover control signal to the changeover valve 54.

If the changeover control signal is set to be the neutral signal from the feather signal, the pitch angle of each blade 20 is started to change (ascend) as illustrated in FIG. 6A. Thereafter, if the changeover control signal is set to be the fine signal, the pitch angle of each blade 20 is started to change (descend) with a time lag, as illustrated in FIG. 6A.

This time lag becomes shorter at the time of changing the pitch angle of each blade 20 from the fine position to the feather position if the function of the pilot check valve 40 is hindered, so that the pitch angle of each blade 20 is started to change earlier than the case of the normal operation of the pilot check valve 40. This is because the function of the pilot check valve 40 is hindered and the pressure in the oil pressure chamber 32B is decreased, and when the supply of the hydraulic oil to the oil pressure chamber 32A is started, the hydraulic oil is discharged from the oil pressure chamber 32B more easily compared to the case of the normal operation of the pilot check valve 40.

In the wind turbine generator 10 according to the first embodiment, based on the operation time required for changing the pitch angle of each blade 20 at a predetermined angle (hereinafter referred to as a “first determination criterion”) or on the degree of the pitch angle change of each blade 20 within predetermined time duration (hereinafter referred to as a “second determination criterion”), the operation state of each blade 20 detected in Step 104 is compared to the normal operation state thereof.

A specific example of the first determination criterion is the operation time required for the pitch angle to change by 50% from the feather position to the full-fine position. A specific example of the second determination criterion is the degree of the pitch angle change within a half of the time required for the piston 34 to be pushed most inward of the oil hydraulic cylinder 32 at the minimum driving speed.

Based on the first determination criterion, if the operation time in the operation state of each blade 20 detected in Step 104 is shorter than that in the normal operation state, the operation state of each blade 20 is abnormal; to the contrary, if both are the same, the operation state of each blade 20 is normal.

Based on the second determination criterion, if the degree of the pitch angle in the operation state of each blade 20 detected in Step 104 is greater than that in the normal operation state, the operation state of each blade 20 is abnormal; to the contrary, if both are the same, the operation state of each blade 20 is normal.

Specifically, the function of the pilot check valve 40 is hindered and oil leakage occurs on the pilot check valve 40, so that the pressure of the hydraulic oil in the oil hydraulic cylinder 32 is decreased, thus the operation state of each blade 20 during the process of changing the pitch angle from the feather position to the fine position differs from the normal operation state. Accordingly, it can be determined whether or not there is any abnormality in the pilot check valve 40 by comparing the detected operation state of each blade 20 to the normal operation state.

In following Step 110, it is determined whether or not the operation state of each blade 20 is normal, and if the determination is “Yes”, the process shifts to Step 112, and if the determination is “No”, the process shifts to Step 114.

In Step 112, the informing unit 64 is instructed to inform that the pilot check valve 40 operates normally, and the program is completed.

In Step 114, the informing unit 64 is instructed to inform that the pilot check valve 40 operates abnormally.

In following Step 116, it is determined whether or not the number of abnormalities detected by executing the program is a predetermined value or more (five, for example), and if the determination is “Yes”, the process shifts to Step 120, and if the determination is “No”, the process shifts to Step 118.

In Step 118, the recovery operation is executed to solve the abnormality in the pilot check valve 40, and when the recovery operation is completed, the process returns to Step 100. Specifically, in the function checking process of the pilot check valve according to the first embodiment, the recovery operation is repetitively executed at predetermined times until the abnormality in the pilot check valve 40 is removed.

The recovery operation according to the first embodiment generates a flow of the hydraulic oil in the hydraulic oil supply passage 36B, which enables the oil hydraulic cylinder 32 to operate repetitively, thereby removing contaminants mixed in the pilot check valve 40 from the pilot check valve 40.

Specifically, the recovery operation repetitively generates a flow of the hydraulic oil for pushing the piston 34 outward of the oil hydraulic cylinder 32 at the minimum speed so as to change the pitch angle of each blade 20 to the feather position, and generates a flow of the hydraulic oil for pushing the piston 34 into the oil hydraulic cylinder 32 at the maximum speed so as to change the pitch angle of each blade 20 to the fine position.

Why the piston 34 is pushed outward of the oil hydraulic cylinder 32 at the minimum speed is the following reason: the flow for pushing the piston 34 outward of the oil hydraulic cylinder 32 may draw the contaminants mixed in the pilot check valve 40 into the oil hydraulic cylinder 32, and a rapid flow is prevented from being generated in the hydraulic oil so as not to generate such an inconvenience.

To the contrary, why the piston 34 is pushed into the oil hydraulic cylinder 32 at the maximum speed is the following reason: the flow for pushing the piston 34 into the oil hydraulic cylinder 32 serves for feeding the contaminants mixed in the pilot check valve 40 into the oil tank, and a rapid flow is generated in the hydraulic oil so as to securely remove the contaminants from the pilot check valve 40.

The removed contaminants are cleared out in the oil tank or through a filter or the like.

In Step 120, if the recovery operation is repetitively executed at the predetermined times and the operation state of each blade 20 cannot be normal, the informing unit 64 is instructed to inform that the abnormality in pilot check valve 40 cannot be solved and the program is completed. If an operator recognizes that the abnormality in the pilot check valve 40 cannot be solved through the informing unit 64, the operator will perform a certain maintenance operation to remove the abnormality from the pilot check valve 40.

As described above, the wind turbine generator 10 according to the first embodiment detects the operation state of each blade 20 during the process of changing the pitch angle of each blade 20 from the feather position to the fine position, and compares the detected operation state of each blade 20 to the normal operation state stored in the memory unit 62 in advance, so as to determine if there is any abnormality in the pilot check valve 40.

Accordingly, the wind turbine generator 10 according to the first embodiment can readily check the normality of the function of the pilot check valve 40.

The wind turbine generator 10 according to the first embodiment generates the flow of the hydraulic oil for enabling the oil hydraulic cylinder 32 to operate repetitively, thereby removing the contaminants mixed in the pilot check valve 40 from the pilot check valve 40, thus the pilot check valve 40 can readily be recovered from the abnormal state to the normal state.

In the wind turbine generator 10 according to the first embodiment, the operation state of each blade 20 used for determining whether or not there is any abnormality in the pilot check valve 40 is based on the relation between the change amount of the pitch angle of each blade 20 and the time duration required for changing the pitch angle of each blade 20. Accordingly, no new configuration is necessary for detecting the operation state of each blade 20, which facilitates the determination of the abnormality in the pilot check valve 40.

### Second Embodiment

Hereinafter, descriptions will now be provided on the second embodiment of the present invention.

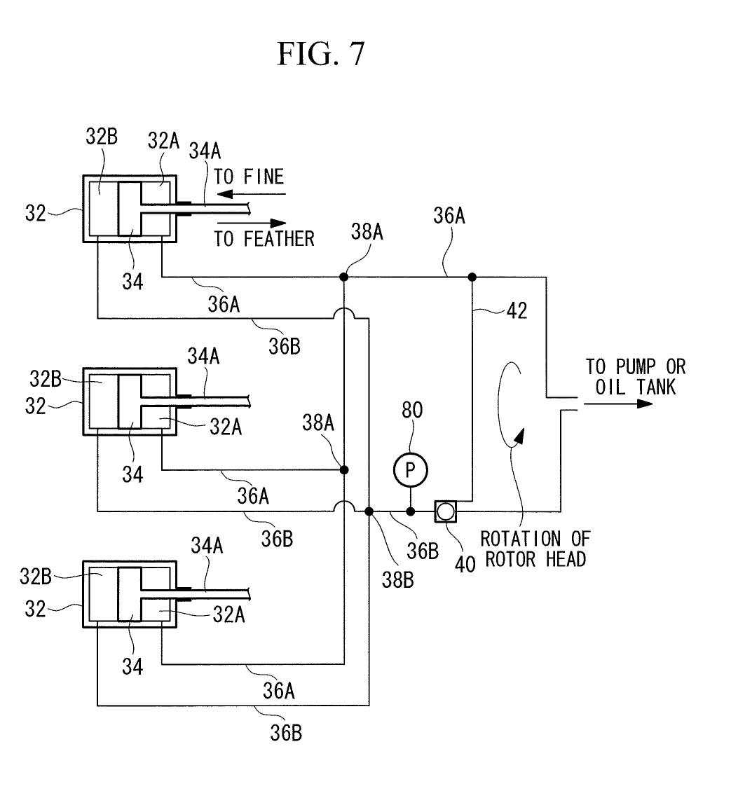

FIG. 7 illustrates the configuration of the oil hydraulic circuit 30 according to the second embodiment. The same reference numerals will be given to the same elements in FIG. 7 as those described in FIG. 2, and any detailed explanation will be omitted.

The oil hydraulic circuit 30 according to the second embodiment includes the oil pressure sensor 80 for detecting the pressure of the hydraulic oil supplied to the oil hydraulic cylinder 32. Specifically, the oil pressure sensor 80 is disposed between the pilot check valve 40 in the hydraulic oil supply passage 36B and the branch 38B.

The function checking process of the pilot check valve according to the second embodiment uses the pressure detected by the oil pressure sensor 80 as the operation state of the blade 20.

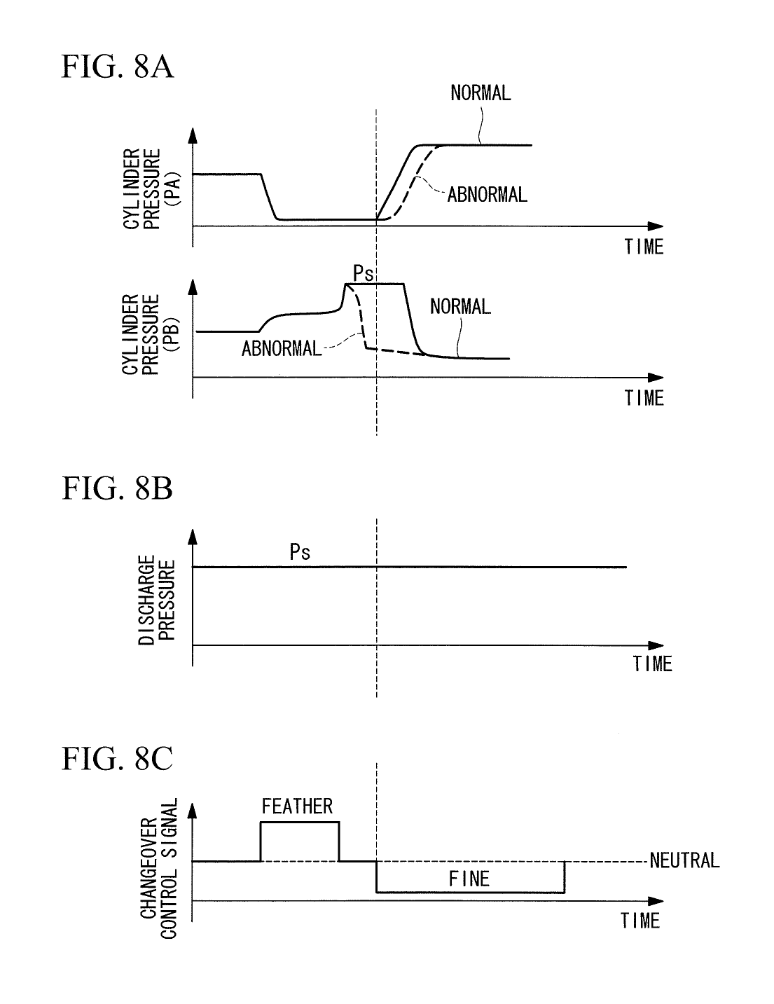

FIG. 8A is a graph of showing the change in pressure of the hydraulic oil in the oil hydraulic cylinder 32, FIG. 8B is a drawing of illustrating the pressure of the hydraulic oil discharged from the pump 52, and FIG. 8C is a drawing of illustrating the state of the changeover control signal output from the control system 50 to the changeover valve 54.

The cylinder pressure (PA) of the upper graph of FIG. 8A represents the pressure of the hydraulic oil in the oil pressure chamber 32A. If the pitch angle of each blade 20 is set at the fine position, the cylinder pressure (PA) of the pilot check valve 40 in the abnormal state (broken line) starts to ascend later than the cylinder pressure (PA) of the pilot check valve 40 in the normal state (solid line). This is because the pressure in the oil pressure chamber 32B cannot be maintained due to the abnormality in the pilot check valve 40.

On the other hand, the cylinder pressure (PB) of the lower graph of FIG. 8A represents the pressure of the hydraulic oil in the oil pressure chamber 32B. The cylinder pressure (PB) in the abnormal state (broken line) of the pilot check valve 40 is not maintained at the discharge pressure Ps after the pitch angle of each blade 20 is set at the feather position. This is because the pressure of the oil pressure chamber 32B is easily released due to the abnormality in the pilot check valve 40.

The function checking process of the pilot check valve according to the second embodiment compares the pressure detected by the oil pressure sensor 80 as the operation state of each blade 20 to the cylinder pressure (PB) in the normal operation state, so as to determine whether or not there is any abnormality in the pilot check valve 40.

Since the pressure of the hydraulic oil is directly subject to influence from hindrance of the function of the pilot check valve 40, the wind turbine generator 10 according to the second embodiment can determine whether or not there is any abnormality in the pilot check valve 40 with higher accuracy.

The oil pressure sensor 80 is disposed more closely to the pump 52 than the branch 38A of the hydraulic oil supply passage 36A, and the pressure detected by this oil pressure sensor 80 as the detected operation state of each blade 20 may be compared to the normal operation state, so as to determine whether or not there is any abnormality in the pilot check valve 40.

### Third Embodiment

Hereinafter, descriptions will now be provided on the third embodiment of the present invention.

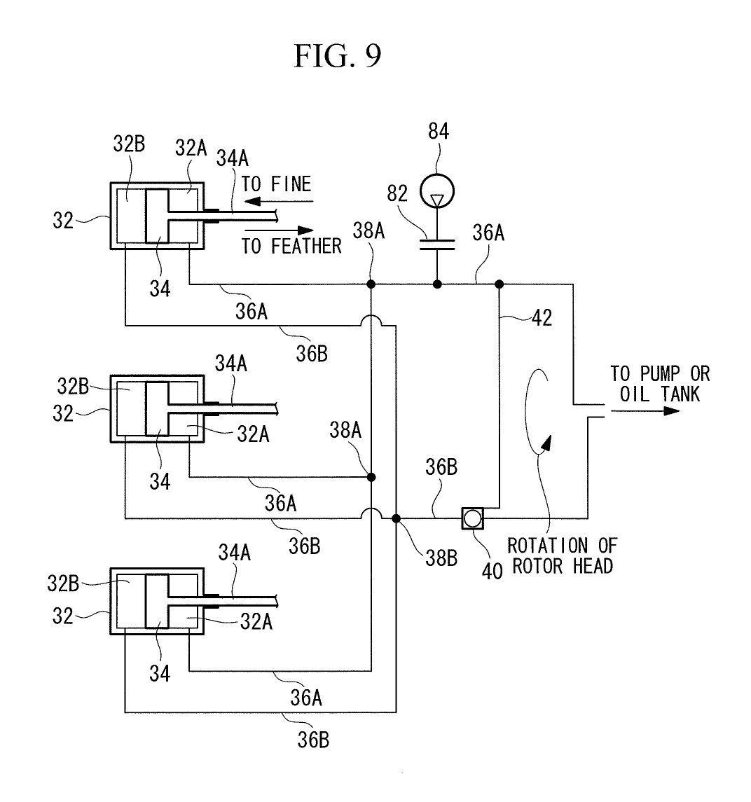

FIG. 9 illustrates the configuration of the oil hydraulic circuit 30 according to the third embodiment. The same reference numerals will be given to the same elements in FIG. 9 as those described in FIG. 2, and any detailed explanation will be omitted.

In the oil hydraulic circuit 30 according to the third embodiment, the maintenance port 82 for supplying the hydraulic oil to the oil hydraulic cylinder 32 is disposed between the oil hydraulic cylinder 32 and the pump 52 (closer to the pump 52 than the branch 38A of the hydraulic oil supply passage 36A).

The pump 84 is connected to the maintenance port 82 so that the pitch angle of each blade 20 at the feather position can be changed to the fine position.

The function checking process of the pilot check valve according to the third embodiment detects the operation state of each blade 20 when the hydraulic oil is supplied from the maintenance port 82 using the pump 84 in order to change the pitch angle of each blade 20 at the feather position to the fine position.

The function checking process of the pilot check valve according to the third embodiment also compares the above described operation state to the normal operation state, so as to determine whether or not there is any abnormality in the pilot check valve 40. The normal operation state preferably represents the operation state of each blade 20 in which the pilot check valve 40 normally operates and the hydraulic oil is supplied from the maintenance port 82.

As described above, the maintenance port 82 is disposed more closely to the oil hydraulic cylinder 32 than the pump 52 for supplying the hydraulic oil to the oil hydraulic cylinder 32 in the normal operation. Therefore, the configuration of supplying the hydraulic oil from the maintenance port 82 to the oil hydraulic cylinder 32 can reduce influence on the operation state of the blade 20 due to pressure loss of the hydraulic oil, compared to the configuration of supplying the hydraulic oil from the pump 52 to the oil hydraulic cylinder 32.

Accordingly, the wind turbine generator 10 according to the third embodiment can determine whether or not there is any abnormality in the pilot check valve 40 with higher accuracy.

As described above, the present invention has been explained by using the various embodiments, but the technical scope of the present invention is not limited to the descriptions of the above embodiments. The present invention may apply various modifications and improvements to the above described embodiments without departing from the spirit and scope of the invention, and these modified and improved embodiments are also included in the technical scope of the present invention.

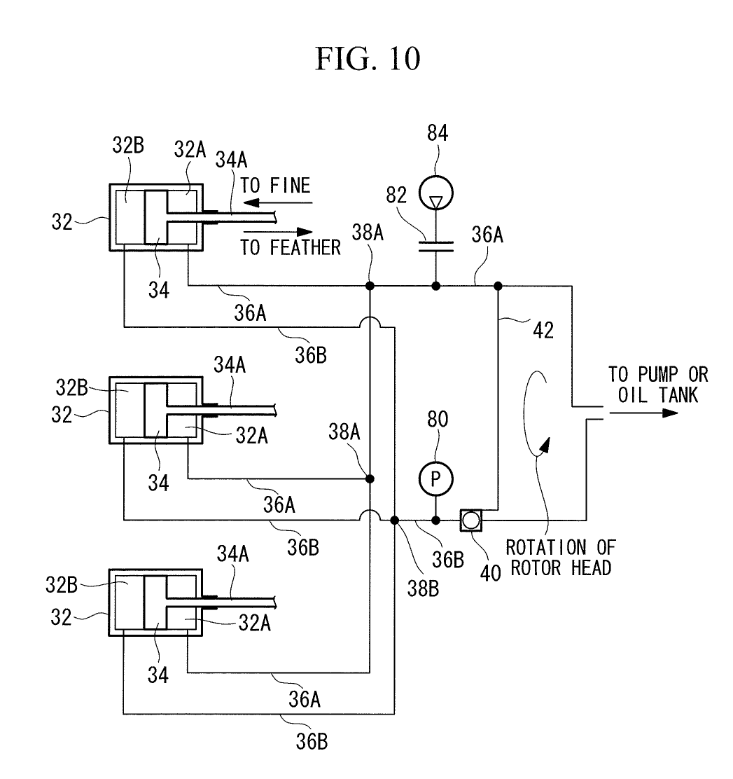

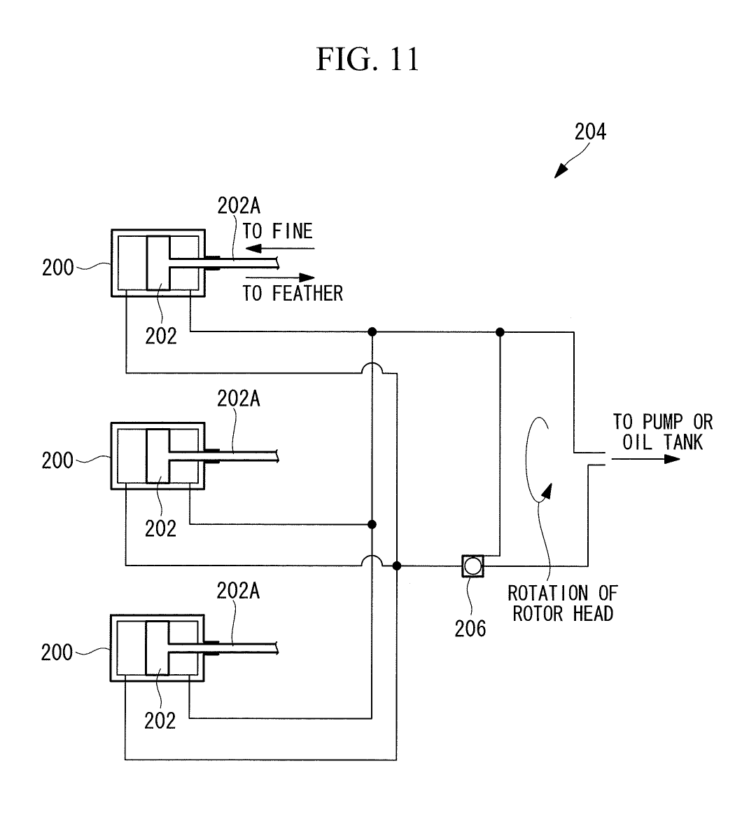

For example, as illustrated in FIG. 10, the oil hydraulic circuit 30 may be provided with the oil pressure sensor 80 according to the second embodiment and the pump 84 according to the third embodiment. In this configuration, any one of the operation state described in the first to third embodiments may be used as the operation state of each blade 20 used for determining whether or not there is any abnormality in the pilot check valve 40.

In the above various embodiments, it has been described that the pitch angle of each blade 20 is set to the feather position when the piston 34 is pushed most outward of the oil hydraulic cylinder 32, and the pitch angle of each blade 20 is set to the fine position when the piston 34 is pushed most inward of the oil hydraulic cylinder 32. The present invention is, however, not limited to this, and the pitch angle of each blade 20 may be set to the fine position when the piston 34 is pushed most outward of the oil hydraulic cylinder 32, and the pitch angle of each blade 20 may be set to the feather position when the piston 34 is pushed most inward of the oil hydraulic cylinder 32. In this configuration, the pilot check valve 40 is disposed in the hydraulic oil supply passage 36A.

In the above various embodiments, it has been described that the oil hydraulic cylinder 32 is provided to each blade 20, and the hydraulic oil supply passages 36A, 36B which supply the hydraulic oil to the oil hydraulic cylinder 32 are commonly used so that the pitch angle of each blade 20 is changed at the same timing. The present invention is, however, not limited to this, the oil hydraulic cylinder 32 is provided to each blade 20 and the hydraulic oil supply passages 36A, 36B are not commonly used, so that the pitch angle of each blade 20 may be variable independently. In this configuration, the pilot check valve 40 is provided to each hydraulic oil supply passage 36B of each oil hydraulic cylinder 32.

In addition, the pitch angle of the multiple blades 20 may be changed by using the single oil hydraulic cylinder 32.

### REFERENCE SIGNS LIST

10 wind turbine generator
20 blade
32 oil hydraulic cylinder
40 pilot check valve
50 control system
60 pitch angle sensor
62 memory unit
80 oil pressure sensor
82 maintenance port

1. A wind turbine generator comprising a pilot check valve for restricting a flow of hydraulic oil relative to an oil hydraulic cylinder for changing a pitch angle of a blade,
the pilot check valve functioning for fixing the pitch angle of the blade to a feather position in a state in which rotation of the blade is stopped,
the wind turbine generator further comprising:
a detection unit for detecting an operation state of the blade during a process of changing the pitch angle of the blade from the feather position to a fine position;
a memory unit for storing in advance a normal operation state that is an operation state of the blade during a process of changing the pitch angle of the blade from the feather position to the fine position when the pilot check valve functions normally; and
a determination unit for determining whether or not there is any abnormality in the pilot check valve by comparing the operation state of the blade detected by the detection unit to the normal operation state stored on the memory unit in advance.

2. The wind turbine generator according to claim 1, further comprising
a solution unit for solving an abnormality in the pilot check valve by generating a flow of the hydraulic oil for allowing the oil hydraulic cylinder to operate repetitively if it is determined by the determination unit that there is an abnormality in the pilot check valve.

3. The wind turbine generator according to claim 1, wherein
the operation state comprises a relation between change amount of the pitch angle of the blade and time duration required for changing the pitch angle of the blade.

4. The wind turbine generator according to claim 1, wherein
the operation state comprises pressure of the hydraulic oil supplied to the oil hydraulic cylinder.

5. The wind turbine generator according to claim 1, wherein
a maintenance port for supplying the hydraulic oil to the oil hydraulic cylinder is provided in order to enable the pitch angle of the blade at the feather position to be changed to the fine position, and the maintenance port is disposed between the oil hydraulic cylinder and a pump for supplying the hydraulic oil to the oil hydraulic cylinder at a time of a normal operation, and
the detection unit detects the operation state of the blade when the hydraulic oil is supplied from the maintenance port in order to change the pitch angle of the blade at the feather position to the fine position.

6. A valve function checking method for a wind turbine generator comprising a pilot check valve for restricting a flow of hydraulic oil relative to an oil hydraulic cylinder for changing a pitch angle of a blade, the pilot check valve functioning for fixing the pitch angle of the blade to a feather position in a state in which rotation of the blade is stopped,
the valve function checking method comprising:
a first stage of detecting an operation state of the blade during a process of changing the pitch angle of the blade from the feather position to a fine position; and
a second stage of determining whether or not there is any abnormality in the pilot check valve by comparing the operation state of the blade detected by the first stage to a normal operation state stored on a memory unit in advance, the normal operation state being an operation state of the blade during a process of changing the pitch angle of the blade from the feather position to the fine position when the pilot check valve functions normally.
